(19) United States
(12) Patent Application Publication
(10) Pub. No.: US 2025/0087923 A1
(43) Pub. Date: Mar. 13, 2025

(54) CONNECTOR

(71) Applicant: SUMITOMO WIRING SYSTEMS, LTD., Mie (JP)

(72) Inventor: Junya ITO, Mie (JP)

(21) Appl. No.: 18/728,457

(22) PCT Filed: Jan. 6, 2023
(86) PCT No.: PCT/JP2023/000215

§ 371 Date: Jul. 12, 2024

(30) Foreign Application Priority Data
Jan. 20, 2022 (JP) 2022-007102

(51) Int. Cl. H01R 13/405

(52) U.S. Cl. CPC H01R 13/405

(57) ABSTRACT

A first terminal includes a first connecting portion including a contact point with a first mating terminal, the first connecting portion being an end region including a first end in the first terminal, and a first intermediate portion adjacent to the first connecting portion in an extension direction of the first terminal. A second terminal includes a second connecting portion including a contact point with a second mating terminal, the second connecting portion being an end region including a second end in the second terminal. The first connecting portion and the second connecting portion are entirely exposed from a housing. The first intermediate portion includes a first exposed portion exposed from the housing, the first exposed portion being an end region adjacent to the first connecting portion in the first intermediate portion, and a first embedded portion embedded in the housing.

### TECHNICAL FIELD

The present disclosure relates to a connector.

### BACKGROUND

Conventionally, some connectors include a linearly extending terminal and a connector housing for holding the terminal. For example, a connector described in Patent Document 1 includes one linearly extending terminal. A part of the terminal is embedded in the connector housing by insert molding.

### PRIOR ART DOCUMENT

### Patent Document

Patent Document 1: JP 2011-060499 A

### SUMMARY OF THE INVENTION

### Problems to be Solved

A connector may be provided with two types of terminals including a first terminal and a second terminal thicker than the first terminal. In this case, a mold for molding a connector housing includes a first terminal arrangement hole for inserting a part of the first terminal exposed from the connector housing and a second terminal arrangement hole for inserting a part of the second terminal exposed from the connector housing. By filling a resin into the mold with the first terminal inserted in the first terminal arrangement hole and the second terminal inserted in the second terminal arrangement hole, the connector housing integrated with the first and second terminals is formed.

However, in arranging the first and second terminals in the mold, the first terminal is insertable into the second terminal arrangement hole for inserting the second terminal since being thinner than the second terminal. If each of the first and second terminals linearly extends, an error of inserting the first terminal into the second terminal arrangement hole easily occurs since the first and second terminals are similar in shape. Thus, there has been a possibility of forming such a connector that the first terminal is arranged in a place where the second terminal should be arranged. Therefore, it has been desired to suppress arrangement errors of two types of terminals different in thickness.

The present disclosure aims to provide a connector capable of suppressing arrangement errors of two types of terminals different in thickness.

### Means to Solve the Problem

The present disclosure is directed to a connector with a connector housing, at least one first terminal linearly extending, the first terminal being partially embedded in the connector housing, and at least one second terminal linearly extending, the second terminal being partially embedded in the connector housing, the first terminal including a first end, the first end being one end of the first terminal in an extension direction of the first terminal, a first connecting portion including a contact point with a first mating terminal, the first connecting portion being an end region including the first end in the first terminal, and a first intermediate portion adjacent to the first connecting portion in the extension direction of the first terminal, the second terminal including a second end, the second end being one end of the second terminal in an extension direction of the second terminal, and a second connecting portion including a contact point with a second mating terminal, the second connecting portion being an end region including the second end in the second terminal, the first connecting portion being entirely exposed from the connector housing, the first intermediate portion including a first exposed portion exposed from the connector housing, the first exposed portion being an end region adjacent to the first connecting portion in the first intermediate portion, and a first embedded portion adjacent to the first exposed portion in the extension direction of the first terminal and embedded in the connector housing, the first exposed portion being thicker than the first connecting portion, and the second connecting portion projecting from a surface of the connector housing in the same direction as the first connecting portion, the second connecting portion being entirely exposed from the connector housing, thicker than the first connecting portion and thinner than the first exposed portion.

### Effect of the Invention

According to a connector of the present disclosure, arrangement errors of two types of terminals different in thickness can be suppressed.

### BRIEF DESCRIPTION OF THE DRAWINGS

FIG. 1 is a schematic diagram showing a state where a connector in one embodiment is mounted on an enclosure.

FIG. 2 is a perspective view of the connector in the embodiment.

FIG. 3 is a side view of the connector in the embodiment.

FIG. 4 is a section of the connector in the embodiment.

FIG. 5 is a section of the connector in the embodiment.

FIG. 6 is a plan view of a first terminal in the embodiment.

FIG. 7 is a plan view of a second terminal in the embodiment.

FIG. 8 is a perspective view showing a part of the connector in the embodiment.

FIG. 9 is a section showing a part of the connector in the embodiment.

FIG. 10 is a diagram showing a step of arranging the first and second terminals in the embodiment in a mold.

FIG. 11 is a diagram showing the step of arranging the first and second terminals in the embodiment in the mold.

### DETAILED DESCRIPTION TO EXECUTE THE INVENTION

### Description of Embodiments of Present Disclosure

First, embodiments of the present disclosure are listed and described.
[1] The connector of the present disclosure is provided with a connector housing, at least one first terminal linearly extending, the first terminal being partially embedded in the connector housing, and at least one second terminal linearly extending, the second terminal being partially embedded in the connector housing, the first terminal including a first end, the first end being one end of the first terminal in an extension direction of the first terminal, a first connecting portion including a contact point with a first mating terminal, the first connecting portion being an end region including the first end in the first terminal, and a first intermediate portion adjacent to the first connecting portion in the extension direction of the first terminal, the second terminal including a second end, the second end being one end of the second terminal in an extension direction of the second terminal, and a second connecting portion including a contact point with a second mating terminal, the second connecting portion being an end region including the second end in the second terminal, the first connecting portion being entirely exposed from the connector housing, the first intermediate portion including a first exposed portion exposed from the connector housing, the first exposed portion being an end region adjacent to the first connecting portion in the first intermediate portion, and a first embedded portion adjacent to the first exposed portion in the extension direction of the first terminal and embedded in the connector housing, the first exposed portion being thicker than the first connecting portion, and the second connecting portion projecting from a surface of the connector housing in the same direction as the first connecting portion, the second connecting portion being entirely exposed from the connector housing, thicker than the first connecting portion and thinner than the first exposed portion.

According to this configuration, a mold for molding the connector housing integrated with the first and second terminals includes a first terminal arrangement hole for inserting the first connecting portion and the first exposed portion exposed from the connector housing. To expose the first connecting portion and the first exposed portion from the connector housing, the inner surface of the first terminal arrangement hole is shaped to correspond to the outer shapes of the first connecting portion and the first exposed portion. That is, the first terminal arrangement hole is shaped to be closed by the first connecting portion and the first exposed portion so that a molten resin material being filled into the mold does not enter the inside of the first terminal arrangement hole. Further, this mold includes a second terminal arrangement hole for inserting the second connecting portion exposed from the connector housing. To expose the second connecting portion from the connector housing, the inner surface of the second terminal arrangement hole is shaped to correspond to the outer shape of the second connecting portion. That is, the second terminal arrangement hole is shaped to be closed by the second connecting portion so that the molten resin material being filled into the mold does not enter the inside of the second terminal arrangement hole. When the connector housing integrated with the first and second terminals is formed, the arrangement position of the first terminal in the connector is determined by inserting the first connecting portion and the first exposed portion into the first terminal arrangement hole. Further, the arrangement position of the second terminal in the connector is determined by inserting the second connecting portion into the second terminal arrangement hole.

The first connecting portion of the first terminal is thinner than the second connecting portion of the second terminal. On the other hand, the first exposed portion of the first terminal is thicker than the second connecting portion. Accordingly, a part of the first terminal arrangement hole where the first connecting portion is inserted and arranged is thinner than the second terminal. A part of the first terminal arrangement hole where the first exposed portion is inserted and arranged is thicker than the second terminal. The second terminal arrangement hole is thicker than the first connecting portion, but thinner than the first exposed portion.

Thus, if the first terminal is erroneously inserted into the second terminal arrangement hole, the first connecting portion is inserted into the second terminal arrangement hole, but the first exposed portion cannot be inserted into the second terminal arrangement hole. Accordingly, the first terminal is prevented from being inserted into the second terminal arrangement hole any further by the first exposed portion being caught by an opening of the second terminal arrangement hole. Therefore, it can be suppressed that the first terminal is set in the mold with the first connecting portion inserted in the second terminal arrangement hole, i.e. the first terminal is arranged in a place where the second terminal should be arranged in the mold.

Further, if the second terminal is erroneously inserted into the first terminal arrangement hole, the second connecting portion cannot be inserted into a part of the first arranging portion having an inner surface corresponding to the outer shape of the first connecting portion. Therefore, it can be suppressed that the second terminal is set in the mold with the second connecting portion inserted in the first terminal arrangement hole, i.e. the second terminal is arranged in a place where the first terminal should be arranged in the mold.

From these, arrangement errors of two types of the terminals different in thickness can be suppressed. That is, it can be suppressed that the second terminal is arranged in the place where the first terminal should be arranged or the first terminal is arranged in the place where the second terminal should be arranged when the housing is molded. Further, it can be suppressed that, in the connector, the second terminal is arranged in the place where the first terminal should be arranged or the first terminal is arranged in the place where the second terminal should be arranged.
[2] Preferably, the first terminal includes a third end, the third end being an end opposite to the first end in the extension direction of the first terminal, a third connecting portion including a contact point with a third mating terminal, the third connecting portion being an end region including the third end in the first terminal, and a second intermediate portion adjacent to the third connecting portion in the extension direction of the first terminal, the second terminal includes a fourth end, the fourth end being an end opposite to the second end in the extension direction of the second terminal, and a fourth connecting portion including a contact point with a fourth mating terminal, the fourth connecting portion being an end region including the fourth end in the second terminal, the third connecting portion is entirely exposed from the connector housing, the second intermediate portion includes a second exposed portion exposed from the connector housing, the second exposed portion being an end region adjacent to the third connecting portion in the second intermediate portion, and a second embedded portion adjacent to the second exposed portion in the extension direction of the first terminal and embedded in the connector housing, the second exposed portion is thicker than the third connecting portion, and the fourth connecting portion projects from the connector housing in the same direction as the third connecting portion and is entirely exposed from the connector housing, thicker than the third connecting portion and thinner than the second exposed portion.

According to this configuration, the first terminal has the contact points with the different mating terminals on both ends in the first direction. Further, the second terminal has the contact points with the different mating terminals on both ends in the second direction. A thickness relationship of the first connecting portion, the first exposed portion and the second connecting portion is equal to that of the third connecting portion, the second exposed portion and the fourth connecting portion. Thus, it can be suppressed as described above that the fourth connecting portion is erroneously inserted into the third terminal arrangement hole of the mold for molding the connector housing integrated with the first and second terminals, into which hole the third connecting portion and the second exposed portion are inserted. Therefore, it can be suppressed that the second terminal is set in the mold with the fourth connecting portion inserted in the third terminal arrangement hole. Further, it can be suppressed as described above that the third connecting portion and the second exposed portion are erroneously inserted into the fourth terminal arrangement hole of the mold, into which the fourth connecting portion is inserted. Therefore, it can be suppressed that the first terminal is set in the mold with the third connecting portion inserted in the fourth terminal arrangement hole.

As just described, it can be suppressed that the first terminal is arranged in the place where the second terminal should be arranged in the mold, not only in the end region where the first connecting portion is provided in the first terminal, but also in the end region where the third connecting portion is provided in the first terminal. Further, it can be suppressed that the second terminal is arranged in the place where the first terminal should be arranged in the mold, not only in the end region where the second connecting portion is provided in the second terminal, but also in the end region where the fourth connecting portion is provided in the second terminal. Therefore, arrangement errors of the two types of the terminals different in thickness can be suppressed also in the end region where the third connecting portion is provided in the first terminal and in the end region where the fourth connecting portion is provided in the second terminal.
[3] Preferably, the connector housing includes a first recess, the first exposed portion being arranged inside the first recess, and a second recess, the second exposed portion being arranged inside the second recess. According to this configuration, the first exposed portion arranged inside the first recess can be visually confirmed. Further, the second exposed portion arranged inside the second recess can be visually confirmed. Therefore, whether or not the first terminal is arranged in the place where the first terminal should be arranged in the connector can be easily confirmed by confirming whether or not the first exposed portion is arranged inside the first recess. Similarly, whether or not the first terminal is arranged in the place where the first terminal should be arranged in the connector can be easily confirmed by confirming whether or not the second exposed portion is arranged inside the second recess.
[4] Preferably, each of the first and second terminals is in the form of a flat plate. According to this configuration, each of the first and second terminals can be easily formed by press-working. Manufacturing cost can be reduced, for example, as compared to the case where each of the first and second terminals is formed by cutting.
[5] Preferably, the connector housing includes a tubular portion having a tubular shape surrounding outer peripheries of the first and second connecting portions and an erroneous assembly preventing protrusion projecting from an outer peripheral surface of the tubular portion. According to this configuration, if a connector housing of a first mating connector includes a first erroneous assembly preventing groove, into which the first erroneous assembly preventing protrusion is inserted along the first direction, the first mating connector is suppressed from being fit in a wrong posture into the first tubular portion. For example, the first mating connector can be suppressed from being fit into the first tubular portion while being shifted around an axis passing through a center of the first tubular portion and extending along the first direction from a correct posture with respect to the first tubular portion.

### Details of Embodiments of Present Disclosure

A specific embodiment of a connector of the present disclosure is described below with reference to the drawings. For the convenience of description, some components may be shown in an exaggerated or simplified manner in each drawing. A dimension ratio of each part may be different in each drawing. In each drawing, XYZ axes intersecting perpendicular to each other are shown. “Parallel” and “perpendicular” in this specification mean not only strictly parallel and perpendicular, but also substantially parallel and perpendicular within a range in which functions and effects in this embodiment are achieved. Further, a term “tubular” used in the description of this specification indicates not only a shape formed by a peripheral wall continuous over an entire periphery in a circumferential direction, but also a shape formed by combining a plurality of components and a shape having a cut or the like in a circumferential part such as a C shape. Note that the “tubular” shapes include circular shapes, elliptical shapes and polygonal shapes with angular or rounded corners, but there is no limitation to these. Note that the present invention is not limited to these illustrations, but is represented by claims and intended to include all changes in the scope of claims and in the meaning and scope of equivalents.

Hereinafter, one embodiment of a connector is described.

### (Overall Configuration of Connector 21)

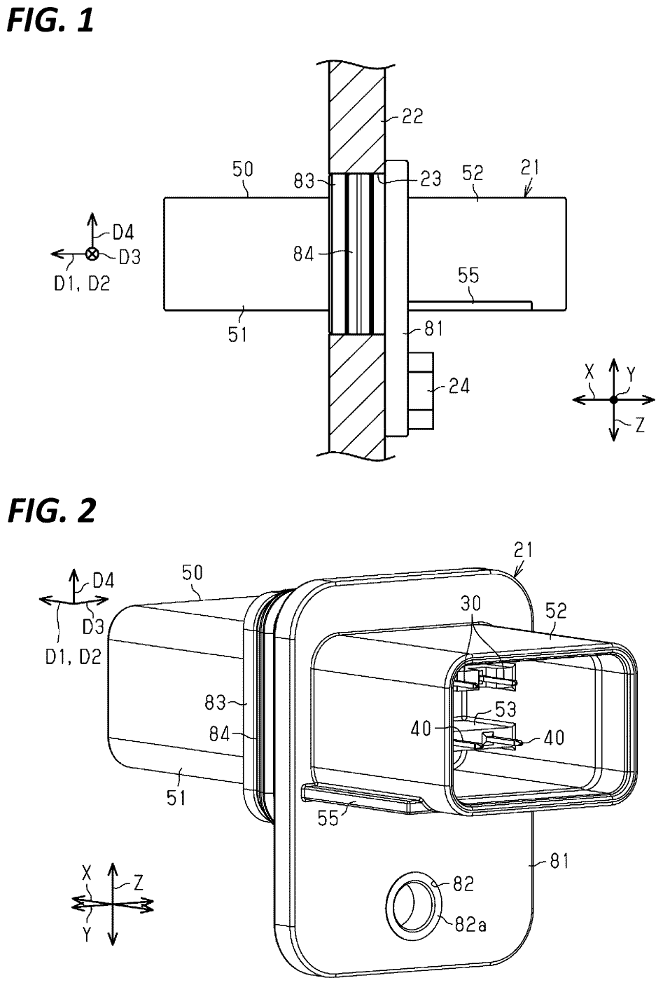

As shown in FIG. 1, a connector 21 is, for example, fixed to an enclosure 22. The enclosure 22 accommodates, for example, an electrical device to be installed in a vehicle. The enclosure 22 may include a mounting hole 23. The mounting hole 23 allows communication between an internal space of the enclosure 22 and an external space of the enclosure 22.

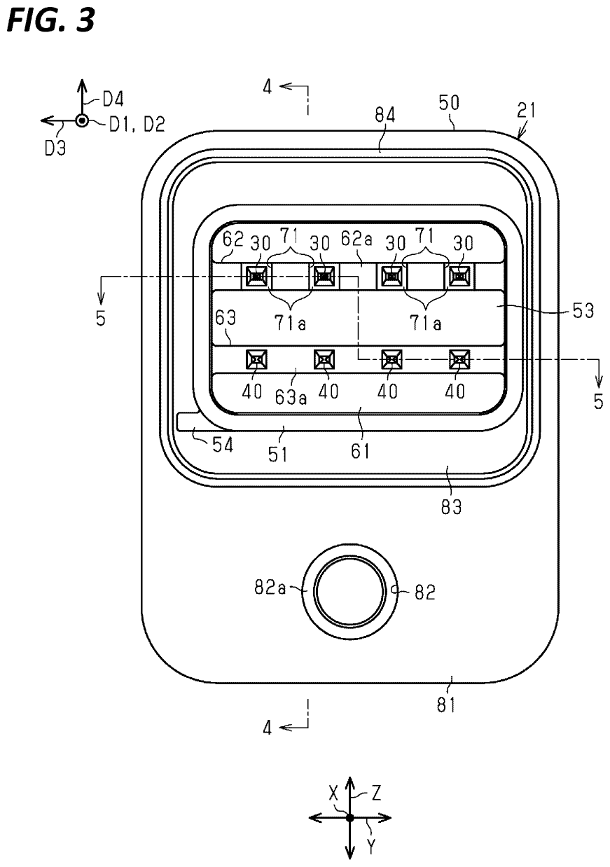

As shown in FIGS. 2 and 3, the connector 21 is provided with a connector housing 50, at least one first terminal 30 and at least one second terminal 40. The connector 21 is, for example, provided with four first terminals 30. Further, the connector 21 is, for example, provided with four second terminals 40. Note that the connector housing 50 is abbreviated and written as the “housing 50” below.

### (Configurations of First Terminals 30 and Second Terminals 40)

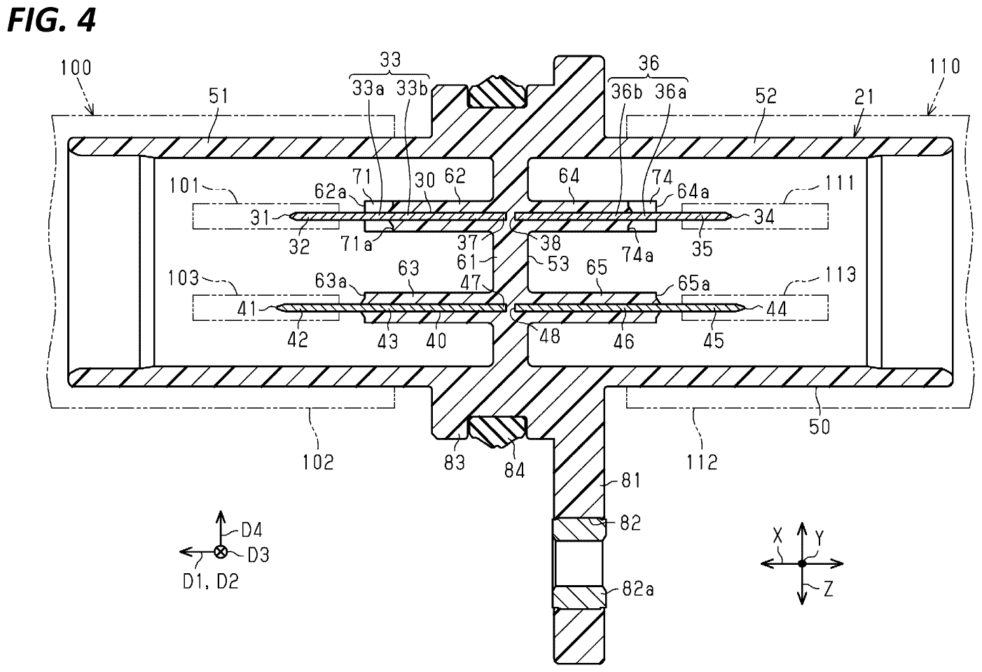

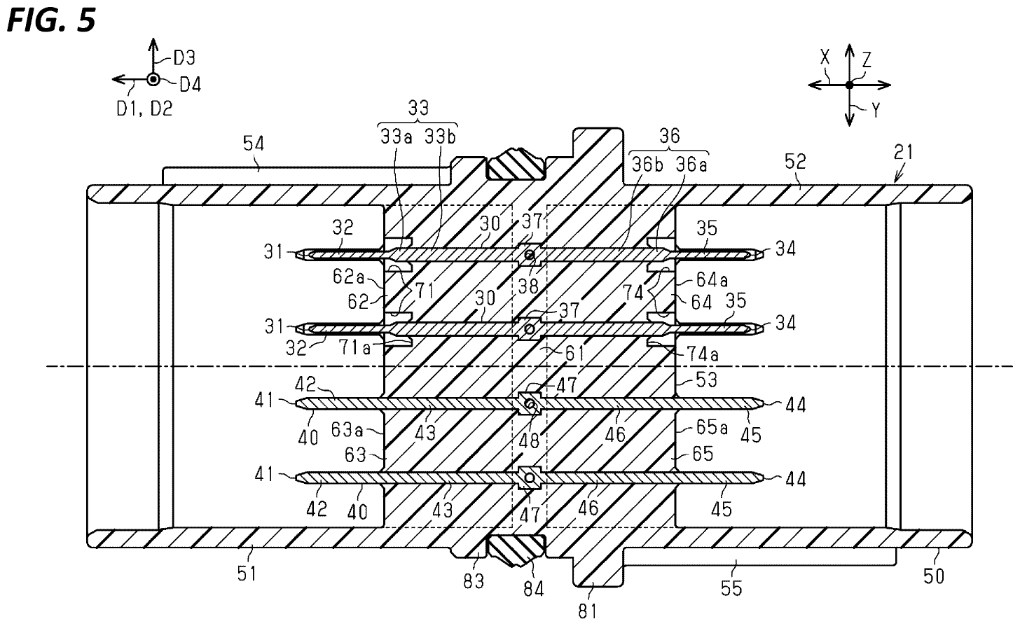

As shown in FIGS. 4 and 5, each of the first and second terminals 30, 40 is partially embedded in the housing 50. Note that FIG. 4 is a section along 4-4 in FIG. 3. FIG. 5 is a section along 5-5 in FIG. 3.

Each first terminal 30 linearly extends. Here, an extension direction of each first terminal 30 is referred to as a first direction D1. The first direction D1 is, for example, a direction along the X axis. A plurality of the first terminals 30 are arranged in parallel to each other in the connector 21.

Each first terminal 30 includes a first end 31, which is one end of the first terminal 30 in the first direction D1. Further, each first terminal 30 includes a first connecting portion 32, which is an end region including the first end 31 in each first terminal 30, and a first intermediate portion 33 adjacent to the first connecting portion 32 in the first direction D1. The first connecting portion 32 includes a contact point with a first mating terminal 101. The first mating terminal 101 is provided in a first mating connector 100 to be connected to the connector 21. The first mating connector 100 is provided with a mating connector housing 102 for holding the first mating terminals 101.

Each first terminal 40 linearly extends. Here, an extension direction of each second terminal 40 is referred to as a second direction D2. The second direction D2 is, for example, a direction along the X axis. Further, the second direction D2 is a direction parallel to the first direction D1. For example, the second direction D1 is the same direction as the first direction D1. Further, one direction perpendicular to the first direction D1 is referred to as a third direction D3. The third direction D3 is, for example, a direction along the Y axis. Further, a direction perpendicular to each of the first direction D1 and the third direction D3 is referred to as a fourth direction D4. The fourth direction D4 is, for example, a direction along the Z axis.

A plurality of the second terminals 40 are arranged in parallel to each other in the connector 21. Each second terminal 40 includes a second end 41, which is one end of the second terminal 40 in the second direction D2. Further, each second terminal 40 includes a second connecting portion 42, which is an end region including the second end 41 in each second terminal 40. The second connecting portion 42 includes a contact point with a second mating terminal 103. The second mating terminal 103 is provided in a mating connector housing 102.

Further, each first terminal 30 includes a third end 34, which is an end opposite to the first end 31 in the first direction D1. In short, the first direction D1 is, for example, a direction from the first end 31 toward the third end 34 in each first terminal 30. The first end 31 is an end part in the first direction D1 in each first terminal 30. The third end 34 is an end part in a direction opposite to the first direction D1 in each first terminal 30. Each first terminal 30 may include a third connecting portion 35, which is an end region including the third end 34 in each first terminal 30, and a second intermediate portion 36 adjacent to the third connecting portion 35 in the first direction D1. The third connecting portion 35 includes a contact point with a third mating terminal 111. The third mating terminal 111 is provided in a second mating connector 110 to be connected to the connector 21. The second mating connector 110 is provided with a mating connector housing 112 for holding the third mating terminals 111.

Further, each second terminal 40 includes a third end 44, which is an end opposite to the second end 41 in the second direction D2. In short, the second direction D2 is, for example, a direction from the second end 41 toward the fourth end 44 in each second terminal 40. The second end 41 is an end part in the second direction D2 in each second terminal 40. The fourth end 44 is an end part in a direction opposite to the second direction D2 in each second terminal 40. Further, the second end 41 is an end part in the first direction D1 in each second terminal 40. The fourth end 44 is an end part in the direction opposite to the first direction D1 in each second terminal 40. Each second terminal 40 includes a fourth connecting portion 45, which is an end region including the fourth end 44 in each second terminal 40. The fourth connecting portion 45 includes a contact point with a fourth mating terminal 113. The fourth mating terminal 113 is provided in the mating connector housing 112.

Each first terminal 30 and each second terminal 40 are, for example, made of a copper-based metal material. Note that a metal material other than the copper-based metal material may be used as a material for the first and second terminals 30, 40. Each of the first and second terminals 30, 40 is, for example, in the form of a flat plate. Each first terminal 30 and each second terminal 40 are, for example, formed by stamping a metal plate material by press-working.

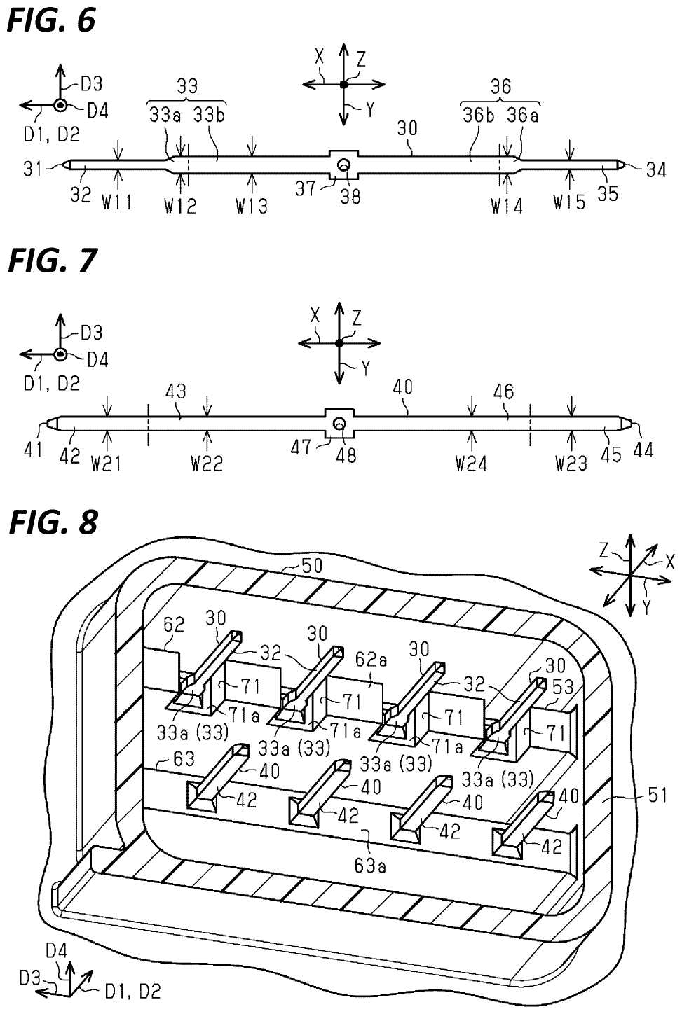

As shown in FIGS. 4 and 6, each first terminal 30 has, for example, a constant thickness. The thickness of the first terminal 30 is, for example, a length of the first terminal 30 in the fourth direction D4. That is, a thickness direction of the first terminal 30 is, for example, the fourth direction D4.

In each first terminal 30, the first connecting portion 32 is, for example, in the form of a rectangular column. For example, a tip region of the first connecting portion 32 becomes thinner toward the first end 31 along the first direction D1. Note that the thickness of the first connecting portion 32 is constant except at the thinned part of the tip region in this first connecting portion 32. Thus, a width W11 of the first connecting portion 32 is constant except at the thinned part of the tip region in this first connecting portion 32. The width W11 of the first connecting portion 32 is, for example, a length of the first connecting portion 32 in the third direction D3. That is, a width direction of each first terminal 30 is, for example, the third direction D3.

In each first terminal 30, the first intermediate portion 33 is, for example, in the form of a strip. The first intermediate portion 33 includes a first exposed portion 33a, which is an end region adjacent to the first connecting portion 32 in the first intermediate portion 33, and a first embedded portion 33b adjacent to the first exposed portion 33a in the first direction D1. Note that a boundary between the first exposed portion 33a and the first embedded portion 33b is shown by a two-dot chain line in FIG. 6.

An end region adjacent to the first connecting portion 32 in the first embedded portion 33b becomes narrower toward the first connecting portion 32. The thickness of the first exposed portion 33a is, for example, constant except at this narrowed part. For example, the first exposed portion 33a has a constant width W12 except at this narrowed part. The width W12 of the first exposed portion 33a is larger than the width W11 of the first connecting portion 32. Thus, if the thickness of the first connecting portion 32 and that of the first exposed portion 33a are equal, the first exposed portion 33a is thicker than the first connecting portion 32.

For example, the first embedded portion 33b has a constant thickness. For example, the first embedded portion 33b has a constant width W13. The width W12 of the first exposed portion 33a and the width W13 of the first embedded portion 33b may be equal. In this case, the first intermediate portion 33 has a constant width except in the end region adjacent to the first connecting portion 32 in the first exposed portion 33a. The first intermediate portion 33 has a constant thickness except in the end region adjacent to the first connecting portion 32 in the first exposed portion 33a.

As shown in FIGS. 4 and 7, each second terminal 40 has, for example, a constant thickness. The thickness of the second terminal 40 is, for example, a length of the second terminal 40 in the fourth direction D4. That is, a thickness direction of the second terminal 40 is, for example, the fourth direction D4. Further, the thickness of the second terminal 40 is, for example, equal to that of the first terminal 30.

In each second terminal 40, the second connecting portion 42 is, for example, in the form of a rectangular column. For example, a tip region of the second connecting portion 42 becomes thinner toward the second end 41 along the second direction D2. Note that the thickness of the second connecting portion 42 is constant except at the thinned part of the tip region in the second connecting portion 42. Thus, a width W21 of the second connecting portion 42 is constant except at the thinned part of the tip region in the second connecting portion 42. The width W21 of the second connecting portion 42 is, for example, a length of the second connecting portion 42 in the third direction D3. That is, a width direction of each second terminal 40 is, for example, the third direction D3.

Each second terminal 40 includes a second terminal side first embedded portion 43. The second terminal side first embedded portion 43 is adjacent to the second connecting portion 42 in the second direction D2. Note that a boundary between the second connecting portion 42 and the second terminal side first embedded portion 43 is shown by a two-dot chain line in FIG. 7. The second terminal side first embedded portion 43 is, for example, in the form of a rectangular plate. The second terminal side first embedded portion 43 has, for example, a thickness equal to that of the second connecting portion 42. A width W22 of the second terminal side first embedded portion 43 is, for example, equal to the width W21 of the second connecting portion 42.

As shown in FIGS. 6 and 7, the second connecting portion 42 is thicker than the first connecting portion 32 and thinner than the first exposed portion 33a. For example, if the thickness of the first connecting portion 32 and that of the second connecting portion 42 are equal, the width W21 of the second connecting portion 42 is larger than the width W11 of the first connecting portion 32 and smaller than the width W12 of the first exposed portion 33a. Further, a length of the second connecting portion 42 in the second direction D2 is larger than that of the first connecting portion 32 in the first direction D1.

The third connecting portion 35 has, for example, the same shape and size as the first connecting portion 32. However, the third and first connecting portions 35, 32 are oriented opposite to each other in the first direction D1.

The second intermediate portion 36 has the same shape and size as the first intermediate portion 33. That is, the second intermediate portion 36 may include a second exposed portion 36a having the same shape as the first exposed portion 33a and a second embedded portion 36b having the same shape as the first embedded portion 33b. The second exposed portion 36a is an end region adjacent to the third connecting portion 35 in the second intermediate portion 36. The second embedded portion 36b is adjacent to the second exposed portion 36a in the first direction D1. Note that the second and first intermediate portions 36, 33 are oriented opposite to each other in the first direction D1.

A width W14 of the second exposed portion 36a is larger than a width W15 of the third connecting portion 35. Thus, if the thickness of the third connecting portion 35 and that of the second exposed portion 36a are equal, the second exposed portion 36a is thicker than the third connecting portion 35.

The fourth connecting portion 45 has, for example, the same shape and size as the second connecting portion 42. Note that the fourth and second connecting portions 45, 42 are oriented opposite to each other in the first direction D1. A width W23 of the fourth connecting portion 45 is larger than the width W15 of the third connecting portion 35 and smaller than the width W14 of the second exposed portion 36a. Thus, if the thicknesses of the third connecting portion 35, the second exposed portion 36a and the fourth connecting portion 45 are equal, the fourth connecting portion 45 is thicker than the third connecting portion 35 and thinner than the second exposed portion 36a. Further, a length of the fourth connecting portion 45 in the second direction D2 is larger than that of the third connecting portion 35 in the first direction D1.

Further, each second terminal 40 includes a second terminal side second embedded portion 46. The second terminal side second embedded portion 46 has, for example, the same shape and size as the second terminal side first embedded portion 43. The second terminal side second embedded portion 46 is adjacent to the fourth connecting portion 45 in the second direction D2. The second terminal side second embedded portion 46 has, for example, a thickness equal to that of the fourth connecting portion 45. A width W24 of the second terminal side second embedded portion 46 is, for example, equal to the width W23 of the fourth connecting portion 45.

As shown in FIG. 6, each first terminal 30 may include a positioning portion 37. The positioning portion 37 is, for example, located between the first embedded portion 33b and the second embedded portion 36b in each first terminal 30. A width of the positioning portion 37 may be larger or smaller than the width W13 of the first embedded portion 33b. For example, the width of the positioning portion 37 is larger than the width W13. The positioning portion 37 includes a through hole 38 penetrating through the positioning portion 37 in the fourth direction D4.

As shown in FIG. 7, each second terminal 40 may include a positioning portion 47. The positioning portion 47 is, for example, located between the second terminal side first embedded portion 43 and the second terminal side second embedded portion 46 in each second terminal 40. A width of the positioning portion 47 may be larger or smaller than the width W22 of the second terminal side first embedded portion 43. For example, the width of the positioning portion 47 is larger than the width W22. The positioning portion 47 includes a through hole 48 penetrating through the positioning portion 47 in the fourth direction D4.

### (Configuration of Connector Housing 50)

As shown in FIGS. 3 to 5, the housing 50 includes, for example, a first tubular portion 51 to be connected to the first mating connector 100, a second tubular portion 52 to be connected to the second mating connector 110 and a holding portion 53 for holding each of the first and second terminals 30, 40. Note that the first mating connector 100 is fit into the first tubular portion 51 in the direction opposite to the first direction D1. Further, the second mating connector 110 is fit into the second tubular portion 52 in the first direction D1.

The housing 50 is made of an insulating resin material. The housing 50 is, for example, made of polybutylene terephthalate (PBT). Note that the resin material constituting the housing 50 may contain a filler such as glass fibers. The housing 50 is a single component in which the first tubular portion 51, the second tubular portion 52 and the holding portion 53 are integrally formed. Further, the housing 50 is an insert-molded article integrated with the first and second terminals 30, 40.

The first tubular portion 51 has a tubular shape surrounding the outer peripheries of the first and second connecting portions 32, 42. The first tubular portion 51 has a tubular shape extending along the first direction D1. Further, the first tubular portion 51 has, for example, a rectangular shape with round corners when viewed from a direction along the first direction D1. The first tubular portion 51 is, for example, shaped to be symmetrical twice with an unillustrated axis passing through a center of the first tubular portion 51 and extending along the first direction D1 as a center.

The housing 50 may include a first erroneous assembly preventing protrusion 54. The first erroneous assembly preventing protrusion 54 projects from the outer peripheral surface of the first tubular portion 51. The first erroneous assembly preventing protrusion 54 is, for example, located on an end of the first tubular portion 51 in the third direction D3 and an end of the first tubular portion 51 in a direction opposite to the fourth direction D4. Further, the first erroneous assembly preventing protrusion 54 projects, for example, in the third direction D3 from the outer peripheral surface of the first tubular portion 51. Further, the first erroneous assembly preventing protrusion 54 extends, for example, along the first direction D1. Although the first tubular portion 51 is shaped to be symmetrical twice with the unillustrated axis passing through the center of the first tubular portion 51 and extending along the first direction D1 as a center, the first tubular portion 51 including the first erroneous assembly preventing protrusion 54 is shaped to be rotationally asymmetrical.

Note that the mating connector housing 102 includes an unillustrated first erroneous assembly preventing groove. The first mating connector 100 is so fit into the first tubular portion 51 that the first erroneous assembly preventing protrusion 54 is inserted into the first erroneous assembly preventing groove along the first direction D1. In this way, it is suppressed that the first mating connector 100 is fit in a wrong posture into the first tubular portion 51. For example, it can be suppressed that the first mating connector 100 is fit into the first tubular portion 51 while being rotated by 180° about the unillustrated axis passing through the center of the first tubular portion 51 and extending along the first direction D1 from a correct posture with respect to the first tubular portion 51.

The second tubular portion 52 has a tubular shape surrounding the outer peripheries of the third and fourth connecting portions 35, 45. The second tubular portion 52 has, for example, the same shape and size as the first tubular portion 51. Therefore, the second tubular portion 52 is not described in detail. Note that the second and first tubular portions 52, 51 are oriented opposite to each other in the first direction D1.

The housing 50 may include a second erroneous assembly preventing protrusion 55. The second erroneous assembly preventing protrusion 55 projects from the outer peripheral surface of the second tubular portion 52. The second erroneous assembly preventing protrusion 55 is, for example, located on an end of the second tubular portion 52 in the direction opposite to the third direction D3 and an end of the second tubular portion 52 in the direction opposite to the fourth direction D4. Further, the second erroneous assembly preventing protrusion 55 projects, for example, in the direction opposite to the third direction D3 from the outer peripheral surface of the second tubular portion 52. Further, the second erroneous assembly preventing protrusion 55 extends, for example, along the first direction D1. Although the second tubular portion 52 is shaped to be symmetrical twice with an axis passing through a center of the second tubular portion 52 and extending along the second direction D1 as a center, the second tubular portion 52 including the second erroneous assembly preventing protrusion 55 is shaped to be rotationally asymmetrical.

Note that the mating connector housing 112 includes an unillustrated second erroneous assembly preventing groove. The second mating connector 110 is so fit into the second tubular portion 52 that the second erroneous assembly preventing protrusion 55 is inserted into the second erroneous assembly preventing groove in the direction opposite to the first direction D1. In this way, it is suppressed that the second mating connector 110 is fit in a wrong posture into the second tubular portion 52.

Each first terminal 30 and each second terminal 40 are partially embedded in the holding portion 53. That is, the holding portion 53 partially covers each first terminal 30 and each second terminal 40.

The holding portion 53 holds the plurality of first terminals 30 in a state parallel to each other. For example, the holding portion 53 holds the plurality of first terminals 30 in such a state that each first terminal 30 extends in parallel to the X axis. Further, the holding portion 53 holds the plurality of first terminals 30 arranged in a row in the third direction D3. Further, the holding portion 53 holds the plurality of first terminals 30 in a state separated from each other. The plurality of first terminals 30 are held at the same position in the first direction D1 by the holding portion 53. Thus, the tips of the plurality of first connecting portions 32 are located in one virtual plane perpendicular to the first direction D1. Further, the tips of the plurality of third connecting portions 35 are located in one virtual plane perpendicular to the first direction D1.

The holding portion 53 holds the plurality of second terminals 40 in a state parallel to each other. For example, the holding portion 53 holds the plurality of second terminals 40 in such a state that each second terminal 40 extends in parallel to each first terminal 30. Further, the holding portion 53 holds the plurality of second terminals 40 arranged in a row in the third direction D3, for example, at positions deviated from the plurality of first terminals 30 in the direction opposite to the fourth direction D4. Further, the holding portion 53 holds the plurality of second terminals 40 in a state separated from each other. The plurality of second terminals 40 are held at the same position in the second direction D2 by the holding portion 53. Thus, the tips of the plurality of second connecting portions 42 are located in one virtual plane perpendicular to the second direction D2. Further, the tips of the plurality of fourth connecting portions 45 are located in one virtual plane perpendicular to the second direction D2.

The holding portion 53 includes, for example, a holding body portion 61, a first supporting portion 62, a second supporting portion 63, a third supporting portion 64 and a fourth supporting portion 65.

The holding body portion 61 is located between the first and second tubular portions 51, 52 in the first direction D1. The first and second tubular portions 51, 52 are coupled via the holding body portion 61. The holding body portion 61 closes an end part of the first tubular portion 51 in the direction opposite to the first direction D1. Further, the holding body portion 61 closes an end part of the second tubular portion 52 in the first direction D1. The holding body portion 61 is in the form of a wall separating an internal space of the first tubular portion 51 and that of the second tubular portion 52.

As shown in FIGS. 4 and 5, the positioning portion 37 of each first terminal 30 and the positioning portion 47 of each second terminal 40 are embedded in the holding portion 53. Each of the positioning portions 37, 47 is, for example, embedded in the holding body portion 61. Part of the resin material constituting the holding portion 53 is filled into each of the through holes 38, 48. Each of the first and second terminals 30, 40 is suppressed from being shifted in position with respect to the housing 50 along the first direction D1 by the resin material filled into the through hole 38 or 48 thereof.

As shown in FIGS. 4, 5 and 8, the first supporting portion 62 projects in the first direction D1 from the holding body portion 61. The first supporting portion 62 is located inside the first tubular portion 51. The first supporting portion 62 may have a first flat surface 62a on a tip part of the first supporting portion 62, i.e. an end part of the first supporting portion 62 in the first direction D1. The first flat surface 62a is, for example, a flat surface perpendicular to the first direction D1.

The first supporting portion 62 may include first recesses 71 recessed in the direction opposite to the first direction D1 from the first flat surface 62a. The first supporting portion 62 includes, for example, as many first recesses 71 as the first terminals 30. The positions of a plurality of the first recesses 71 in the third direction D3 are the same as the positions of the plurality of first terminals 30 in the third direction D3.

The first connecting portion 32 and the first exposed portion 33a of each first terminal 30 may not be embedded in the material of the housing 50 and may be exposed from the housing 50 and are, for example, exposed from the surface of the holding portion 53. The first connecting portion 32 and the first exposed portion 33a of each first terminal 30 project, for example, outwardly of the holding portion 53 in the first direction D1 along the X axis from a bottom surface 71a of each first recess 71. Each first exposed portion 33a projects, for example, into an internal space of each first recess 71 from the bottom surface 71a of each first recess 71. Further, each first exposed portion 33a is, for example, arranged inside each first recess 71. Note that each first embedded portion 33b is embedded in the housing 50. Each first embedded portion 33b is, for example, embedded in the first supporting portion 62. Each first connecting portion 32 is entirely exposed from the housing 50. That is, each first connecting portion 32 includes no part embedded in the housing 50.

The second supporting portion 63 projects in the first direction D1 from the holding body portion 61. The second supporting portion 63 is located at a position deviated from the first tubular portion 51 in the direction opposite to the fourth direction D4 inside the first tubular portion 51. The second supporting portion 63 may have a second flat surface 63a on a tip part of the second supporting portion 63, i.e. an end part of the second supporting portion 63 in the first direction D1. The second flat surface 63a is, for example, a flat surface perpendicular to the first direction D1. The second flat surface 63a is, for example, at the same position as the first flat surface 62a in the first direction D1. That is, the first and second flat surfaces 62a, 63a are, for example, located in the same virtual plane.

The second connecting portion 42 of each second terminal 40 may not be embedded in the material of the housing 50 and may be exposed from the housing 50, and is, for example, exposed from the surface of the holding portion 53. Each second connecting portion 42 projects, for example, outwardly of the holding portion 53 in the first direction D1 along the X axis from the second flat surface 63a. That is, each second connecting portion 42 projects in the same direction as the first connecting portion 32 from the surface of the housing 50. Each second connecting portion 42 is arranged in parallel to each first connecting portion 32 inside the first tubular portion 51. Each second connecting portion 42 is entirely exposed from the housing 50. The second terminal side first embedded portion 43 of each second terminal 42 is embedded in the second supporting portion 63.

If the first mating connector 100 is fit into the first tubular portion 51, the first mating terminals 101 and the first connecting portions 32 are respectively electrically connected and the second mating terminals 103 and the second connecting portions 42 are respectively electrically connected. The first and second mating terminals 101, 103 are, for example, female terminals. By inserting the first connecting portion 32 into the first mating terminal 101, the first mating terminal 101 and the first connecting portion 32 are electrically connected. Further, by inserting the second connecting portion 42 into the second mating terminal 103, the second mating terminal 103 and the second connecting portion 42 are electrically connected.

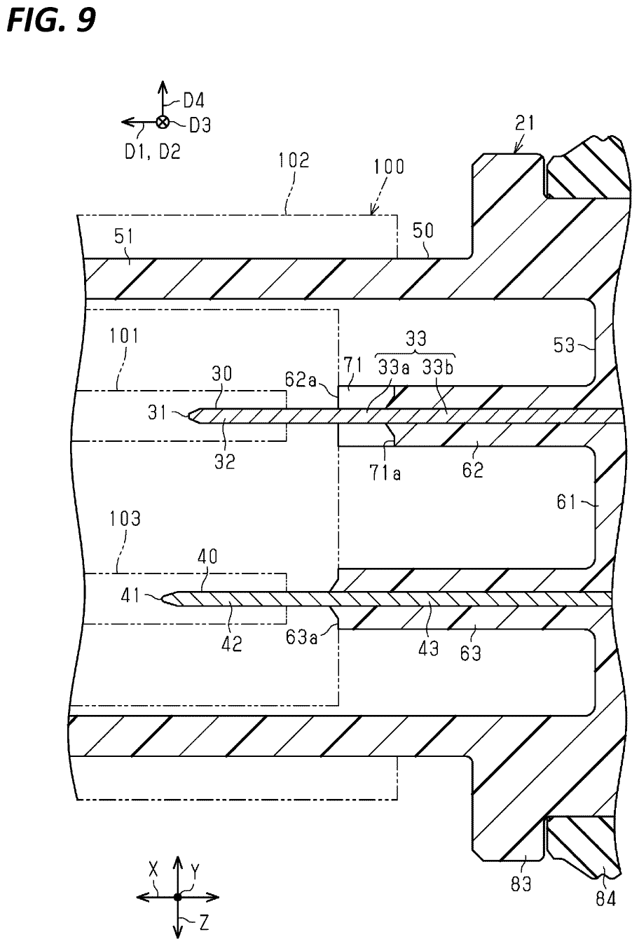

As shown in FIG. 9, the mating connector housing 102 may come into contact with the first and second flat surfaces 62a, 63a from the direction opposite to the first direction D1. In this way, the first mating connector 100 is suppressed from being pushed into the connector 21 more than necessary in the direction opposite to the first direction D1.

As shown in FIGS. 4, 5 and 8, the third supporting portion 64 has, for example, the same configuration as the first supporting portion 62. Note that the third and first supporting portions 64, 62 are oriented opposite to each other in the first direction D1. The third supporting portion 64 may have a third flat surface 64a similar to the first flat surface 62a. Further, the third supporting portion 64 may include as many second recesses 74 similar to the first recesses 71 as the first terminals 30.

The third connecting portion 35 and the second exposed portion 36a of each first terminal 30 may not be embedded in the material of the housing 50 and may be exposed from the housing 50 and are, for example, exposed from the surface of the holding portion 53. The third connecting portion 35 and the second exposed portion 36a of each first terminal 30 project, for example, outwardly of the holding portion 53 in the direction opposite to the first direction D1 along the X axis from a bottom surface 74a of each second recess 74. Each second exposed portion 36a projects, for example, into an internal space of each second recess 74 from the bottom surface 74a of each second recess 74. Further, each second exposed portion 36a is, for example, arranged inside each second recess 74. Note that each second embedded portion 36b is embedded in the housing 50. Each second embedded portion 36b is, for example, embedded in the third supporting portion 64. Each third connecting portion 35 is entirely exposed from the housing 50.

The fourth supporting portion 65 has the same configuration as the second supporting portion 63. Note that the fourth and second supporting portions 65, 63 are oriented opposite to each other in the first direction D1. The fourth supporting portion 65 may have a fourth flat surface 65a similar to the second flat surface 63a.

The fourth connecting portion 45 of each second terminal 40 may not be embedded in the material of the housing 50 and may be exposed from the housing 50 and is, for example, exposed from the surface of the holding portion 53. Each fourth connecting portion 45 projects, for example, outwardly of the holding portion 53 in the direction opposite to the first direction D1 along the X axis from the fourth flat surface 65a. That is, each fourth connecting portion 45 projects in the same direction as the third connecting portion 35 from the surface of the housing 50. Each fourth connecting portion 45 is arranged in parallel to each third connecting portion 35 inside the second tubular portion 52. Each fourth connecting portion 45 is entirely exposed from the housing 50. The second terminal side second embedded portion 46 of each second terminal 42 is embedded in the fourth supporting portion 65. Note that only the second and fourth connecting portions 42, 45 of each second terminal 40 are, for example, exposed from the housing 50.

If the second mating connector 110 is fit into the second tubular portion 52, the third mating terminals 111 and the third connecting portions 35 are respectively electrically connected and the fourth mating terminals 113 and the fourth connecting portions 45 are respectively electrically connected. The third and fourth mating terminals 111, 113 are, for example, female terminals. By inserting the third connecting portion 35 into the third mating terminal 111, the third mating terminal 111 and the third connecting portion 35 are electrically connected. Further, by inserting the fourth connecting portion 45 into the fourth mating terminal 113, the fourth mating terminal 113 and the fourth connecting portion 45 are electrically connected. Note that the mating connector housing 112 may come into contact with the third and fourth flat surfaces 64a, 65a from the first direction D1. In this way, the second mating connector 110 is suppressed from being pushed into the connector 21 more than necessary in the first direction D1.

As shown in FIGS. 1 to 4, the housing 50 may include a fixing portion 81 for fixing the connector 21 to the enclosure 22. The fixing portion 81 is, for example, in the form of a flange extending from the outer peripheral surface of the second tubular portion 52. The fixing portion 81 includes, for example, a fixing hole 82 penetrating through the fixing portion 81 in the first direction D1. For example, a collar 82a is mounted in the fixing hole 82.

Further, the housing 50 may include a fitting portion 83 to be arranged in the mounting hole 23 of the enclosure 22. The fitting portion 83 projects, for example, from the outer peripheral surfaces of the first and second tubular portions 51, 52. The fitting portion 83 is, for example, at a position deviated from the fixing portion 81 in the first direction D1. The fitting portion 83 is adjacent to the fixing portion 81 in the first direction D1. The fitting portion 83 is integrally provided to the fixing portion 81. A sealing member 84 is, for example, mounted on the fitting portion 83. The sealing member 84 seals between the inner peripheral surface of the mounting hole 23 and the outer peripheral surface of the fitting portion 83.

As shown in FIG. 1, the connector 21 is so arranged on the enclosure 22 that the first tubular portion 51 is inserted into the enclosure 22 through the mounting hole 23 and the fitting portion 83 is arranged inside the mounting hole 23. Then, the connector 21 is fixed to the enclosure 22 by a bolt 24 passed through the fixing hole 82.

### (Manufacturing of Connector Housing 50)

A manufacturing example of the housing 50 using a mold is described.

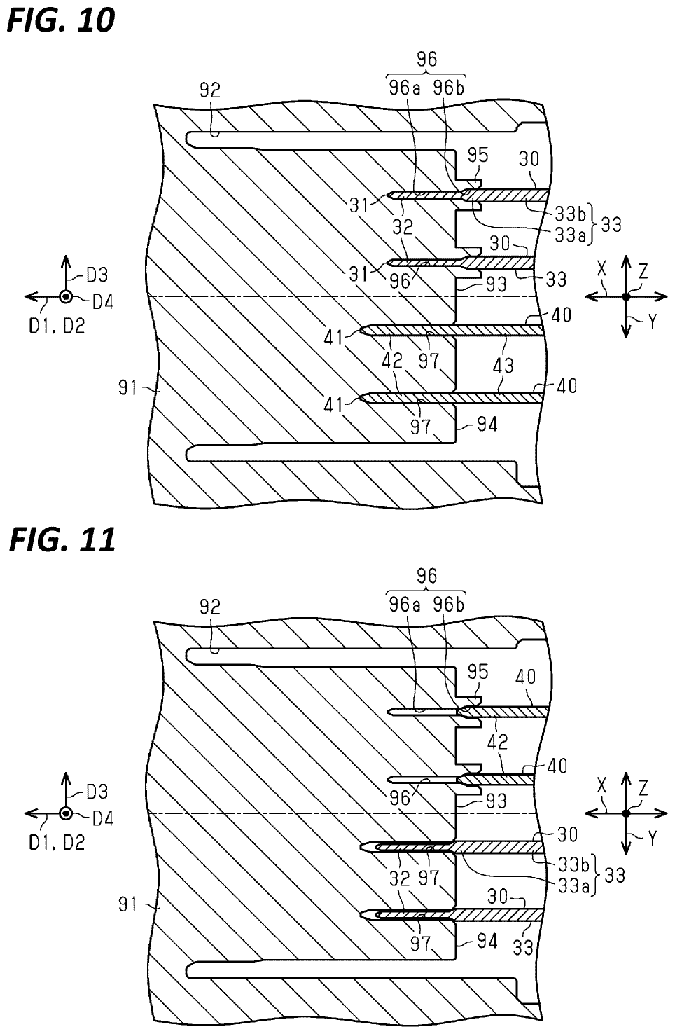

FIG. 10 shows an example of a mold 91 for molding the housing 50. The mold 91 includes a cavity 92 having an inner surface corresponding to the outer shape of the housing 50. The inner surface of the cavity 92 has a first molding surface 93 for forming the first flat surface 62a on the resin material filled into the cavity 92. Further, the inner surface of the cavity 92 has a second molding surface 94 for forming the second flat surface 63a on the resin material filled into the cavity 92. The first and second molding surfaces 93, 94 are, for example, located in the same virtual plane.

The mold 91 includes first recess molding portions 95 projecting from the first molding surface 93. The mold 91 includes as many first recess molding portions 95 as the first terminals 30 provided in the connector 21. The first recess molding portion 95 has an outer surface corresponding to the inner surface of the first recess 71. Further, the mold 91 includes as many first terminal arrangement holes 96 as the first terminals 30 provided in the connector 21. Each first terminal arrangement hole 96 is open in the tip surface of each first recess molding portion 95. Note that only two first recess molding portions 95 and two first terminal arrangement holes 96 are shown in FIG. 10.

The inner surface of each first terminal arrangement hole 96 is shaped to correspond to the outer shapes of the first connecting portion 32 and the first exposed portion 33a. Each first terminal arrangement hole 96 includes a first arranging portion 96a and a second arranging portion 96b. The first arranging portion 96a is a part from a bottom part to a position immediately before an opening in the first terminal arrangement hole 96. The inner surface of the first arranging portion 96a is shaped to correspond to the outer shape of the first connecting portion 32. The second arranging portion 96b is a part between the first arranging portion 96a and the opening of the first terminal arrangement hole 96 in the first terminal arrangement hole 96. The inner surface of the second arranging portion 96b is shaped to correspond to the outer shape of the first exposed portion 33a.

Further, the mold 91 includes second terminal arrangement holes 97 open in the second molding surface 94. The mold 91 includes as many second terminal arrangement holes 97 as the second terminals 40 provided in the connector 21. Note that only two second terminal arrangement holes 97 are shown in FIG. 10. The inner surface of each second terminal arrangement hole 97 is shaped to correspond to the outer shape of the second connecting portion 42.

The first arranging portion 96a of each first terminal arrangement hole 96 is thinner than the second connecting portion 42. Further, the second arranging portion 96b of each first terminal arrangement hole 96 is thicker than the second connecting portion 42. On the other hand, each second terminal arrangement hole 97 is thinner than the first exposed portion 33a.

Note that, although not shown, the inner surface of the cavity 92 has a third molding surface and a fourth molding surface for forming the third flat surface 64a and the fourth flat surface 65a on the resin material filled into the cavity 92. Further, although not shown, the mold 91 includes second recess molding portions projecting from the third molding surface. The second recess molding portion has an outer surface corresponding to the inner surface of the second recess 74. Further, although not shown, the mold 91 includes as many third terminal arrangement holes as the first terminals 30 provided in the connector 21. Each third terminal arrangement hole is open in the tip of each second recess molding portion. Each third terminal arrangement hole is shaped to correspond to the outer shapes of the third connecting portion 35 and the second exposed portion 36a. Each third terminal arrangement hole is, for example, configured similarly to the first terminal arrangement hole 96. Further, although not shown, the mold 91 includes as many fourth terminal arrangement holes open in the fourth molding surface as the second terminals 40 provided in the connector 21. The inner surface of each fourth terminal arrangement hole is shaped to correspond to the outer shape of the fourth connecting portion 45. Each fourth terminal arrangement hole is, for example, configured similarly to the second terminal arrangement hole 97.

Note that the mold 91 is provided with a fixed mold and at least one movable mold. The first and second terminal arrangement holes 96, 97 are, for example, provided in the fixed mold. On the other hand, the third and fourth terminal arrangement holes are, for example, provided in the movable mold(s).

### (Terminal Arrangement Step)

In forming the housing 50 integrated with the first terminals 30 and the second terminals 40 using the above mold 91, a terminal arrangement step of arranging the first and second terminals 30, 40 in the cavity 92 is first performed. In the terminal arrangement step, a worker holds, for example, the plurality of first terminals 30 and the plurality of second terminals 40 by an unillustrated jig. The jig holds the plurality of first terminals 30 and the plurality of second terminals 40 such that a positional relationship of the terminals is the same as that in the connector 21.

Subsequently, the first and second terminals 30, 40 held by the jig are arranged in the cavity 92. At this time, the mold 91 is opened. The first connecting portions 32 and the first exposed portions 33a of the plurality of first terminals 30 are respectively inserted into the first terminal arrangement holes 96. The second connecting portions 42 of the plurality of second terminals 40 are respectively inserted into the second terminal arrangement holes 97. If the first connecting portion 32 and the first exposed portion 33a are properly inserted in the first terminal arrangement hole 96, the entire outer surfaces of the first connecting portion 32 and the first exposed portion 33a are covered by the inner surface of the first terminal arrangement hole 96. Then, the position of each first terminal 30 with respect to the housing 50 to be formed is determined. Further, if the second connecting portion 42 is properly inserted in the second terminal arrangement hole 97, the entire outer surface of the second connecting portion 42 is covered by the inner surface of the second terminal arrangement hole 97. Then, the position of each second terminal 40 with respect to the housing 50 to be formed is determined.

Note that, as shown in FIG. 11, the second connecting portion 42 is thicker than the first arranging portion 96a and thinner than the second arranging portion 96b. Thus, if the second terminal 40 is erroneously inserted into the first terminal arrangement hole 96, the second connecting portion 42 is inserted into the second arranging portion 96b, but cannot be inserted into the first arranging portion 96a. Therefore, the second connecting portion 42 is suppressed from being completely inserted into the first terminal arrangement hole 96. Then, the worker can notice that the second terminal 40 is being erroneously inserted into the first terminal arrangement hole 96 since the second connecting portion 42 cannot be completely inserted.

Further, the first connecting portion 32 is thinner than the second terminal arrangement hole 97, but the first exposed portion 33a is thicker than the second terminal arrangement hole 97. Thus, if the first terminal 30 is erroneously inserted into the second terminal arrangement hole 97, the first connecting portion 32 is inserted into the second terminal arrangement hole 97, but the first exposed portion 33a cannot be inserted into the second terminal arrangement hole 97. Further, the length of the first connecting portion 32 in the first direction D1 is smaller than the length of the second connecting portion 42 in the second direction D2. Thus, before the tip of the first connecting portion 32 reaches a bottom part of the second terminal arrangement hole 97, the first exposed portion 33a is caught by the opening of the second terminal arrangement hole 97. Therefore, the first connecting portion 32 and the first exposed portion 33a are suppressed from being completely inserted into the second terminal arrangement hole 97. If the first terminal 30 is inserted in the first terminal arrangement hole 96, the first exposed portion 33a should be also inserted in the first terminal arrangement hole 96. Therefore, the worker can notice that the first terminal 30 is being erroneously inserted into the second terminal arrangement hole 97 since the first exposed portion 33a cannot be inserted.

After each first terminal 30 is inserted in each first terminal arrangement hole 96 and each second terminal 40 is inserted in each second terminal arrangement hole 97 as shown in FIG. 10, the mold 91 is closed. At this time, the third connecting portions 35 and the second exposed portions 36a of the plurality of first terminals 30 are respectively inserted in the third terminal arrangement holes. Further, the fourth connecting portions 45 of the plurality of second terminals 40 are respectively inserted in the fourth terminal arrangement holes. The terminal arrangement step is finished when the mold 91 is closed.

### (Filling Step)

After the terminal arrangement step, a filling step of filling the resin material into the cavity 92 is performed. In the filling step, the molten resin material is injected into the cavity 92. Then, the resin material is filled into the cavity 92. In this way, the first embedded portions 33b, the second embedded portions 36b, the positioning portions 37, the second terminal side first embedded portions 43, the second terminal side second embedded portions 46 and the positioning portions 47 are embedded in the resin material. The filling step is finished when the resin material is filled into the cavity 92.

After the filling step, the resin material in the cavity 92 is cured by being cooled. By curing the resin material in the cavity 92, the housing 50 integrated with the first terminals 30 and the second terminals 40 is completed. The housing 50 is taken out from the mold 91 after the mold 91 is opened.

Functions and effects of this embodiment are described.
(1) The connector 21 is provided with the housing 50, at least one first terminal 30 linearly extending and partially embedded in the housing 50 and at least one second terminal 40 linearly extending and partially embedded in the housing 50. The first terminal 30 includes the first end 31, which is one end of the first terminal 30 in the extension direction of the first terminal 30, i.e. the first direction D1. Further, the first terminal 30 includes the first connecting portion 32, which is the end region including the first end 31 in the first terminal 30 and includes the contact point with the first mating terminal 101, and the first intermediate portion 33 adjacent to the first connecting portion 32 in the first direction D1. The second terminal 40 includes the second end 41, which is one end of the second terminal 40 in the extension direction of the second terminal 40, i.e. the second direction D2, and the second connecting portion 42, which is the end region including the second end 41 in the second terminal 40 and includes the contact point with the second mating terminal 103. The first connecting portion 32 is entirely exposed from the housing 50. The first intermediate portion 33 includes the first exposed portion 33a, which is the end region adjacent to the first connecting portion 32 in the first intermediate portion 33 and exposed from the housing 50. Further, the first intermediate portion 33 includes the first embedded portion 33b adjacent to the first exposed portion 33a in the first direction D1 and embedded in the housing 50. The first exposed portion 33a is thicker than the first connecting portion 32. The second connecting portion 42 projects from the surface of the housing 50 in the same direction as the first connecting portion 32 and is entirely exposed from the housing 50, thicker than the first connecting portion 32 and thinner than the first exposed portion 33a.

According to this configuration, the mold 91 for molding the housing 50 integrated with the first terminal 30 and the second terminal 40 includes the first terminal arrangement hole 96 for inserting the first connecting portion 32 and the first exposed portion 33a exposed from the housing 50. To expose the first connecting portion 32 and the first exposed portion 33a from the housing 50, the inner surface of the first terminal arrangement hole 96 is shaped to correspond to the outer shapes of the first connecting portion 32 and the first exposed portion 33a. That is, the first terminal arrangement hole 96 is shaped to be closed by the first connecting portion 32 and the first exposed portion 33a so that the molten resin material being filled into the mold 91 does not enter the inside of the first terminal arrangement hole 96. Further, this mold 91 includes the second terminal arrangement hole 97 for inserting the second connecting portion 42 exposed from the housing 50. To expose the second connecting portion 42 from the housing 50, the inner surface of the second terminal arrangement hole 97 is shaped to correspond to the outer shape of the second connecting portion 42. That is, the second terminal arrangement hole 97 is shaped to be closed by the second connecting portion 42 so that the molten resin material being filled into the mold 91 does not enter the inside of the second terminal arrangement hole 97. When the housing 50 integrated with the first terminal 30 and the second terminal 40 is formed, the arrangement position of the first terminal 30 in the connector 21 is determined by inserting the first connecting portion 32 and the first exposed portion 33a into the first terminal arrangement hole 96. Further, the arrangement position of the second terminal 40 is determined by inserting the second connecting portion 42 into the second terminal arrangement hole 97.

The first connecting portion 32 of the first terminal 30 is thinner than the second connecting portion 42 of the second terminal 40. On the other hand, the first exposed portion 33a of the first terminal 30 is thicker than the second connecting portion 42. Accordingly, a part of the first terminal arrangement hole 96 where the first connecting portion 32 is inserted and arranged, i.e. the first arranging portion 96a, is thinner than the second terminal 40. A part of the first terminal arrangement hole 96 where the first exposed portion 33a is inserted and arranged, i.e. the second arranging portion 96b, is thicker than the second terminal 40. The second terminal arrangement hole 97 is thicker than the first connecting portion 32, but thinner than the first exposed portion 33a.

Thus, if the first terminal 30 is erroneously inserted into the second terminal arrangement hole 97, the first connecting portion 32 is inserted into the second terminal arrangement hole 97, but the first exposed portion 33a cannot be inserted into the second terminal arrangement hole 97. Accordingly, the first terminal 30 is prevented from being inserted into the second terminal arrangement hole 97 any further by the first exposed portion 33a being caught by the opening of the second terminal arrangement hole 97. Therefore, it can be suppressed that the first terminal 30 is set in the mold 91 with the first connecting portion 32 inserted in the second terminal arrangement hole 97, i.e. the first terminal 30 is arranged in a place where the second terminal 40 should be arranged in the mold 91.

Further, if the second terminal 40 is erroneously inserted into the first terminal arrangement hole 96, the second connecting portion 42 cannot be inserted into the first arranging portion 96a having the inner surface corresponding to the outer shape of the first connecting portion 32 in the first terminal arrangement hole 96. Therefore, it can be suppressed that the second terminal 40 is set in the mold 91 with the second connecting portion 42 inserted in the first terminal arrangement hole 96, i.e. the second terminal 40 is arranged in a place where the first terminal 30 should be arranged in the mold 91.

From these, arrangement errors of two types of the terminals 30, 40 different in thickness can be suppressed. That is, it can be suppressed that the second terminal 40 is arranged in the place where the first terminal 30 should be arranged or the first terminal 30 is arranged in the place where the second terminal 40 should be arranged when the housing 50 is molded. Further, it can be suppressed that, in the connector 21, the second terminal 40 is arranged in the place where the first terminal 30 should be arranged or the first terminal 30 is arranged in the place where the second terminal 40 should be arranged.
(2) The first terminal 30 includes the third end 34, which is the end opposite to the first end 31 in the first direction D1. Further, the first terminal 30 includes the third connecting portion 35, which is the end region including the third end 34 in the first terminal 30 and includes the contact point with the third mating terminal 111, and the second intermediate portion 36 adjacent to the third connecting portion 35 in the first direction D1. The second terminal 40 includes the fourth end 44, which is the end opposite to the second end 41 in the second direction D2, and the fourth connecting portion 45, which is the end region including the fourth end 44 in the second terminal 40 and includes the contact point with the fourth mating terminal 113. The third connecting portion 35 is entirely exposed from the housing 50. The second intermediate portion 36 includes the second exposed portion 36a, which is the end region adjacent to the third connecting portion 35 in the second intermediate portion 36 and exposed from the housing 50. Further, the second intermediate portion 36 includes the second embedded portion 36b adjacent to the second exposed portion 36a in the first direction D1 and embedded in the housing 50. The second exposed portion 36a is thicker than the third connecting portion 35. The fourth connecting portion 45 projects from the housing 50 in the same direction as the third connecting portion 35 and is entirely exposed from the housing 50, thicker than the third connecting portion 35 and thinner than the second exposed portion 36a.

According to this configuration, the first terminal 30 has the contact points with the different mating terminals 101, 111 on both ends in the first direction D1. Further, the second terminal 40 has the contact points with the different mating terminals 103, 113 on both ends in the second direction D2. A thickness relationship of the first connecting portion 32, the first exposed portion 33a and the second connecting portion 42 is equal to that of the third connecting portion 35, the second exposed portion 36a and the fourth connecting portion 45. Thus, it can be suppressed as described above that the fourth connecting portion 45 is erroneously inserted into the third terminal arrangement hole of the mold 91 for inserting the third connecting portion 35 and the second exposed portion 36a. Therefore, it can be suppressed that the second terminal 40 is set in the mold 91 with the fourth connecting portion 45 inserted in the third terminal arrangement hole. Further, it can be suppressed as described above that the third connecting portion 35 and the second exposed portion 36a are erroneously inserted into the fourth terminal arrangement hole of the mold 91 for inserting the fourth connecting portion 45. Therefore, it can be suppressed that the first terminal 30 is set in the mold 91 with the third connecting portion 35 inserted in the fourth terminal arrangement hole.

As just described, it can be suppressed that the first terminal 30 is arranged in the place where the second terminal 40 should be arranged in the mold 91, not only in the end region where the first connecting portion 32 is provided in the first terminal 30, but also in the end region where the third connecting portion 35 is provided in the first terminal 30. Further, it can be suppressed that the second terminal 40 is arranged in the place where the first terminal 30 should be arranged in the mold 91, not only in the end region where the second connecting portion 42 is provided in the second terminal 40, but also in the end region where the fourth connecting portion 45 is provided in the second terminal 40. Therefore, arrangement errors of the two types of the terminals 30, 40 different in thickness can be suppressed also in the end region where the third connecting portion 35 is provided in the first terminal 30 and in the end region where the fourth connecting portion 45 is provided in the second terminal 40.
(3) The housing 50 includes the first recess 71, in which the first exposed portion 33a is arranged, and the second recess 74, in which the second exposed portion 36a is arranged.

According to this configuration, the first exposed portion 33a arranged inside the first recess 71 can be visually confirmed. Further, the second exposed portion 36a arranged inside the second recess 74 can be visually confirmed. Therefore, whether or not the first terminal 30 is arranged in the place where the first terminal 30 should be arranged in the connector 21 can be easily confirmed by confirming whether or not the first exposed portion 33a is arranged inside the first recess 71. In short, if it cannot be confirmed that the first exposed portion 33a is arranged inside the first recess 71, a possibility that the first terminal 30 is not correctly arranged or the second terminal 40 is arranged in the place where the first terminal 30 should be arranged can be judged. If it cannot be confirmed that the first exposed portion 33a is arranged inside the first recess 71, the connector 21 can be excluded as a defective product. Thus, it is possible to avoid the use of the connector 21 in which the first terminal 30 or the second terminal 40 is not correctly arranged. Similarly, whether or not the first terminal 30 is arranged in the place where the first terminal 30 should be arranged in the connector 21 can be easily confirmed by confirming whether or not the second exposed portion 36a is arranged inside the second recess 74.
(4) Each of the first and second terminals 30, 40 is in the form of a flat plate. According to this configuration, each of the first and second terminals 30, 40 can be easily formed by press-working. Manufacturing cost can be reduced, for example, as compared to the case where each of the first and second terminals 30, 40 is formed by cutting.
(5) The housing 50 includes the first tubular portion 51 having a tubular shape surrounding the outer peripheries of the first connecting portion 32 and the second connecting portion 42 and the first erroneous assembly preventing protrusion 54 projecting from the outer peripheral surface of the first tubular portion 51. According to this configuration, if the mating connector housing 102 includes the first erroneous assembly preventing groove, into which the first erroneous assembly preventing protrusion 54 is inserted along the first direction D1, the first mating connector 100 is suppressed from being fit in a wrong posture into the first tubular portion 51. For example, the mating connector 100 can be suppressed from being fit into the first tubular portion 51 while being shifted around the axis passing through the center of the first tubular portion 51 and extending along the first direction D1 from the correct posture with respect to the first tubular portion 51.

Note that the housing 50 includes the second tubular portion 52 having a tubular shape surrounding the outer peripheries of the third connecting portion 35 and the fourth connecting portion 45 and the second erroneous assembly preventing protrusion 55 projecting from the outer peripheral surface of the second tubular portion 52. Thus, if the mating connector housing 112 includes the second erroneous assembly preventing groove, into which the second erroneous assembly preventing protrusion 55 is inserted along the direction opposite to first direction D1, the second mating connector 110 is suppressed from being fit in a wrong posture into the second tubular portion 52.

This embodiment can be modified and carried out as follows. This embodiment and the following modifications can be carried out in combination without technically contradicting each other.
In the above embodiment, the first and second terminals 30, 40 held by the jig are set in the mold 91 in performing the terminal arrangement step. However, in the terminal arrangement step, the worker may directly arrange each of the first and second terminals 30, 40 in the mold 91 without using the jig.
The housing 50 may not include the first erroneous assembly preventing protrusion 54. Further, the housing 50 may not include the second erroneous assembly preventing protrusion 55.
The width W12 of the first exposed portion 33a and the width W13 of the first embedded portion 33b may have different values. Further, the first embedded portion 33b may not have the constant width W13 along the first direction D1. Similarly, the width W14 of the second exposed portion 36a and the width of the second embedded portion 36b may have different values. Further, the second embedded portion 36b may not have the constant width along the first direction D1.
The end region including the first end 31 in the first terminal 30 and the end region including the third end 34 in the first terminal 30 may have different sizes and/or may have different shapes. Further, the end region including the second end 41 in the second terminal 40 and the end region including the fourth end 44 in the second terminal 40 may have different sizes and/or may have different shapes. However, at least the second connecting portion 42 is thicker than the first connecting portion 32 and thinner than the first exposed portion 33a.
Each of the first and second terminals 30, 40 may not be in the form of a flat plate. For example, at least one of the first and second terminals 30, 40 may be in the form of a column having a circular cross-section. Further, the first and second terminals 30, 40 may have different thicknesses. Further, each of the first and second terminals 30, 40 may not have a constant thickness.
The first terminal 30 may not include the third connecting portion 35 and the second exposed portion 36a. Further, the second terminal 40 may not include the fourth connecting portion 45. In this case, an end part of a wire may be, for example, electrically connected to the end region including the third end 34 in the first terminal 30. Further, an end part of a wire may be, for example, electrically connected to the end region including the fourth end 44 in the second terminal 40. In this case, the housing 50 may not include the second tubular portion 52.
The number of the first terminals 30 provided in the connector 21 is not limited to four and may be three or less or five or more. Further, the number of the second terminals 40 provided in the connector 21 is not limited to four and may be three or less or five or more.
The arrangement positions of the first and second terminals 30, 40 when viewed from the first direction D1 are not limited to those of the above embodiment. The arrangement positions may be appropriately changed according to the specifications of the first and second mating connectors 100, 110. However, the first and second terminals 30, 40 are arranged in parallel to each other.
The shape of the housing 50 is not limited to that of the above embodiment. The shape of each part constituting the housing 50 such as the first tubular portion 51, the second tubular portion 52, the holding portion 53 and the fixing portion 81 can be changed to an arbitrary shape.
The first direction D1 may be a direction from the third end 34 toward the first end 31 in each first terminal 31. The second direction D2 may be a direction from the fourth end 44 toward the second end 41 in each second terminal 40. Further, the direction opposite to the third direction D3 of the above embodiment may be a third direction D3. Further, the direction opposite to the fourth direction D4 of the above embodiment may a fourth direction D4.
As shown in FIGS. 5 and 8, the first recess 71 may have a pair of side surfaces continuous from the bottom surface 71a and extending along the first direction D1, and the first exposed portion 33a may contact neither one of the side surfaces of the first recess 71. The second recess 74 may have a pair of side surfaces continuous from the bottom surface 74a and extending along the first direction D1, and the second exposed portion 36a may contact neither one of the side surfaces of the second recess 74. Gaps may be formed between the first exposed portion 33a and the respective side surfaces of the first recess 71. The first recess 71 may be referred to as a first recess having a depth along the first direction D1. Gaps may be formed between the second exposed portion 36a and the respective side surfaces of the second recess 74. The second recess 74 may be referred to as a second recess having a depth along the first direction D1. A dimension of the first recess 71 in a direction orthogonal to the first direction D1 may be larger than that of the first exposed portion 33a in the direction orthogonal to the first direction D1, and a dimension of the second recess 74 in the direction orthogonal to the first direction D1 may be larger than that of the second exposed portion 36a in the direction orthogonal to the first direction D1.
As shown in FIG. 6, a maximum dimension of the first exposed portion 33a in the third direction D3 may be larger than that of the first connecting portion 32 in the third direction D3, and a maximum dimension of the second connecting portion 42 in the third direction D3 may be larger than that of the first connecting portion 32 in the third direction D3 and smaller than that of the first exposed portion 33a in the third direction D3.

### LIST OF REFERENCE NUMERALS

21 connector
22 enclosure
23 mounting hole
24 bolt
30 first terminal
31 first end
32 first connecting portion
33 first intermediate portion
33a first exposed portion
33b first embedded portion
34 third end
35 third connecting portion
36 second intermediate portion
36a second exposed portion
36b second embedded portion
37 positioning portion
38 through hole
40 second terminal
41 second end
42 second connecting portion
43 second terminal side first embedded portion
44 fourth end
45 fourth connecting portion
46 second terminal side second embedded portion
47 positioning portion
48 through hole
50 connector housing
51 first tubular portion (tubular portion)
52 second tubular portion
53 holding portion
54 first erroneous assembly preventing protrusion (erroneous assembly
preventing protrusion)
55 second erroneous assembly preventing protrusion
61 holding body portion
62 first supporting portion
62a first flat surface
63 second supporting portion
63a second flat surface
64 third supporting portion
64a third flat surface
65 fourth supporting portion
65a fourth flat surface
71 first recess
71a bottom surface
74 second recess
74a bottom surface
81 fixing portion
82 fixing hole
82a collar
83 fitting portion
84 sealing member
91 mold
92 cavity
93 first molding surface
94 second molding surface
95 first recess molding portion
96 first terminal arrangement hole
96a first arranging portion
96b second arranging portion
97 second terminal arrangement hole
100 first mating connector
101 first mating terminal
102 mating connector housing
103 second mating terminal
110 second mating connector
111 third mating terminal
112 mating connector housing
113 fourth mating terminal
D1 first direction (extension direction of first terminal)
D2 second direction (extension direction of second terminal)
D3 third direction
D4 fourth direction
W11 width (width of first connecting portion)
W12 width (width of first exposed portion)
W13 width (width of first embedded portion)
W14 width (width of second exposed portion)
W15 width (width of third connecting portion)
W21 width (width of second connecting portion)
W22 width (width of second terminal side first embedded portion)
W23 width (width of fourth connecting portion)
W24 width (width of second terminal side second embedded portion)

1. A connector, comprising:
a connector housing;
at least one first terminal linearly extending, the first terminal being partially embedded in the connector housing; and
at least one second terminal linearly extending, the second terminal being partially embedded in the connector housing,
the first terminal including a first end, the first end being one end of the first terminal in an extension direction of the first terminal, a first connecting portion including a contact point with a first mating terminal, the first connecting portion being an end region including the first end in the first terminal, and a first intermediate portion adjacent to the first connecting portion in the extension direction of the first terminal,
the second terminal including a second end, the second end being one end of the second terminal in an extension direction of the second terminal, and a second connecting portion including a contact point with a second mating terminal, the second connecting portion being an end region including the second end in the second terminal,
the first connecting portion being entirely exposed from the connector housing,
the first intermediate portion including a first exposed portion exposed from the connector housing, the first exposed portion being an end region adjacent to the first connecting portion in the first intermediate portion, and a first embedded portion adjacent to the first exposed portion in the extension direction of the first terminal and embedded in the connector housing,
the first exposed portion being thicker than the first connecting portion, and
the second connecting portion projecting from a surface of the connector housing in the same direction as the first connecting portion, the second connecting portion being entirely exposed from the connector housing, thicker than the first connecting portion and thinner than the first exposed portion.

2. The connector of claim 1, wherein:
the first terminal includes a third end, the third end being an end opposite to the first end in the extension direction of the first terminal, a third connecting portion including a contact point with a third mating terminal, the third connecting portion being an end region including the third end in the first terminal, and a second intermediate portion adjacent to the third connecting portion in the extension direction of the first terminal,
the second terminal includes a fourth end, the fourth end being an end opposite to the second end in the extension direction of the second terminal, and a fourth connecting portion including a contact point with a fourth mating terminal, the fourth connecting portion being an end region including the fourth end in the second terminal,
the third connecting portion is entirely exposed from the connector housing,
the second intermediate portion includes a second exposed portion exposed from the connector housing, the second exposed portion being an end region adjacent to the third connecting portion in the second intermediate portion, and a second embedded portion adjacent to the second exposed portion in the extension direction of the first terminal and embedded in the connector housing,
the second exposed portion is thicker than the third connecting portion, and
the fourth connecting portion projects from the connector housing in the same direction as the third connecting portion and is entirely exposed from the connector housing, thicker than the third connecting portion and thinner than the second exposed portion.

3. The connector of claim 2, wherein the connector housing includes a first recess, the first exposed portion being arranged inside the first recess, and a second recess, the second exposed portion being arranged inside the second recess.

4. The connector of claim 1, wherein each of the first and second terminals is in the form of a flat plate.

5. The connector of claim 1, wherein the connector housing includes a tubular portion having a tubular shape surrounding outer peripheries of the first and second connecting portions and an erroneous assembly preventing protrusion projecting from an outer peripheral surface of the tubular portion.
